(19) United States
(12) Patent Application Publication
(10) Pub. No.: US 2009/0240526 A1
(43) Pub. Date: Sep. 24, 2009

(54) Systems and Methods for a Medical Device Data Processor

(75) Inventors: Guy Robert Vesto, Kildeer, IL (US); Jay Nayanaveettil, Palatine, IL (US); Saikat Ghosh, Richmond Hill (CA)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 12/051,487

(22) Filed: Mar. 19, 2008

(51) Int. Cl. G06Q 50/00

(52) U.S. Cl. 705/3

(57) ABSTRACT

Certain embodiments of the present invention provide a medical device data processor comprising a connector component adapted to receive clinical data from a plurality of medical devices; a data processor component adapted to receive the clinical data from the connector component; and an integration component adapted to receive the processed clinical data from the data processor component and provide the processed clinical data to an integrated information system. The data processor component comprises a content-based router and a plurality of data processing pipelines. The content-based router is adapted to provide the clinical data to one or more of the plurality of data processing pipelines. The data processing pipelines are adapted to process the clinical data.

### BACKGROUND OF THE INVENTION

The present invention generally relates to processing data from medical devices. In particular, the present invention relates to systems and methods for a medical device data processor.

Medical devices include devices such as physiological monitors, infusion pumps, ventilators, oximeters, fetal monitors, lab instruments, portable vitals measuring equipment, warmers, and dialysis machines. Medical devices are important to the practice of modern medicine. For example, in a hospital intensive care unit (ICU) a variety of medical devices may surround each patient, each performing an important task. A patient connected to one or more vital-signs monitors may also be receiving drugs or other fluids under the control of an infusion pump, for example. In some cases, a patient may have some of their physiological processes supported by medical devices such as ventilators.

From a clinician's perspective, getting the right information at the right time is important in order to improve the quality and efficiency of care. Electronic charting of a patient's record depends on the correct information being extracted from a constant stream of data from bedside devices.

Collecting patient vital sign data from medical devices has become a critical component of the integrated healthcare environment. This information is an important to clinical care. Voluminous data records are created for each patient from the output of the various medical devices. The information is displayed on nursing flow sheets and is used to provide accurate, complete, and timely information to clinical decision support, alerting, protocols, electronic charting, and be stored as part of the Electronic Medical Record (EMR). However, not all device data should go into the patient's longitudinal (“official”) medical record. Unless steps are taken, the voluminous data generated by monitoring devices can easily pollute the EMR with excess quantities or misleading data.

Current systems cannot effectively integrate data from a wide variety of medical devices. Currently, medical devices are made by more than 1,000 manufactures. It is difficult to bring together multiple devices into interoperable (inter-connected) systems to improve patient care and avoid unnecessary accidents. Not only do clinical information systems need to be able to connect to them, but they also need to connect to legacy devices that are in use in acute care environments. Medical devices are no longer purchased as stand-alone devices. Rather, hospitals expect a connectivity solution, no matter what information system they may have implemented.

One reason current electronic charting and clinical decision systems cannot effectively integrate the data from multiple medical devices is the lack of uniform data standards. Many device manufacturers have developed their own proprietary protocols, depending on the type of device they provide and on their specific interfacing strategy. However, there is no agreed-upon data standard. Formats including MIB, HL7, XML and other proprietary standards represent solutions that do not match all customers' requirements and which are dependent on the Clinical Information System (CIS), Electronic Patient Record (EPR) or other Healthcare Information System (HCIS) that they have chosen. Current systems do not provide for improvement of data quality and mining device data.

Medical device communication today is lacking well-accepted standards and is challenged by regulatory factors and international mandates such as FDA 510K and the open EU interface commission. The lack of standards has lead to an abundance of proprietary solutions from device vendors such as General Electric, Philips, and Siemens and an “impedance mismatch” between medical devices and CIS. That is, a particular CIS may not be able to communicate with many of the medical devices that “speak” different “languages.”

The CIS and the hospital's network infrastructure may also be strained by the network traffic generated by an abundance of concurrently connected bedside devices common in enterprise deployment scenarios.

Thus, current systems do not improve the quality of data and improve Clinical Decision Support.

### BRIEF SUMMARY OF THE INVENTION

Certain embodiments of the present invention provide a medical device data processor comprising a connector component adapted to receive clinical data from a plurality of medical devices; a data processor component adapted to receive the clinical data from the connector component; and an integration component adapted to receive the processed clinical data from the data processor component and provide the processed clinical data to an integrated information system. The data processor component comprises a content-based router and a plurality of data processing pipelines. The content-based router is adapted to provide the clinical data to one or more of the plurality of data processing pipelines. The data processing pipelines are adapted to process the clinical data.

Certain embodiments of the present invention provide a method for processing medical device data comprising receiving clinical data from a plurality of medical devices at a device data processor through a plurality of medical device gateways; processing the clinical data at the device data processor using a content-based router and a plurality of data processing pipelines; and providing the processed clinical data to an integrated information system. The content-based router is adapted to provide the clinical data to one or more of the plurality of data processing pipelines. The data processing pipelines are adapted to process the clinical data.

Certain embodiments of the present invention provide a computer-readable medium including a set of instructions for execution on a computer, the set of instructions comprising a connector component routine configured to receive clinical data from a plurality of medical devices; a data processor component routine configured to receive the clinical data from the connector component routine; and an integration component routine configured adapted to receive the processed clinical data from the data processor component and provide the processed clinical data to an integrated information system. The data processor component routine comprises a content-based router routine and a plurality of data processing pipeline routines. The content-based router routine is configured to provide the clinical data to one or more of the plurality of data processing pipeline routines. The data processing pipeline routines are configured to process the clinical data.

### BRIEF DESCRIPTION OF SEVERAL VIEWS OF THE DRAWINGS

FIG. 1 illustrates a block diagram of a data processing system according to an embodiment of the present invention.

FIG. 2 illustrates a data processing system according to an embodiment of the present invention.

FIG. 3 illustrates a data flow diagram for a device data processor according to an embodiment of the present invention.

FIG. 4 illustrates a composed message processor of a device data processor according to an embodiment of the present invention.

FIG. 5 illustrates an intelligent system according to an embodiment of the present invention.

FIG. 6 illustrates a flow diagram for a method for processing medical device data according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments of the present invention provide a high-throughput and scalable medical device data processing engine and connectivity bus leveraging an open connector-based architecture for easy and consistent integration of medical devices with information systems such as CIS. Certain embodiments enable enhanced computerized decision support, access to a broader range of devices, and tighter device-EMR integration. Certain embodiments provide data analysis, mining, and quality improvement of medical device data, allowing more effective computerized decision support. Certain embodiments allow for highly effective intelligent systems can be created when combined with clinical decision support engines.

Certain embodiments provide improved patient safety through, for example, reduced medication errors and adverse events and improved medication and test ordering. Certain embodiments provide improved quality of care by, for example, providing clinicians with the right information at the right time, increasing clinicians' available time for direct patient care, increased application of clinical pathways and guidelines, facilitating the use of up-to-date clinical evidence, improved clinical documentation, and patient satisfaction. Certain embodiments provide improved efficiency in health care delivery by, for example, reducing costs through electronic patient charting and decreased adverse events. Certain embodiments provide improved quality of data and better decision support. Certain embodiments provide uniform access to medical device data. Certain embodiments provide simplified and uniform integration of diverse sets of medical devices.

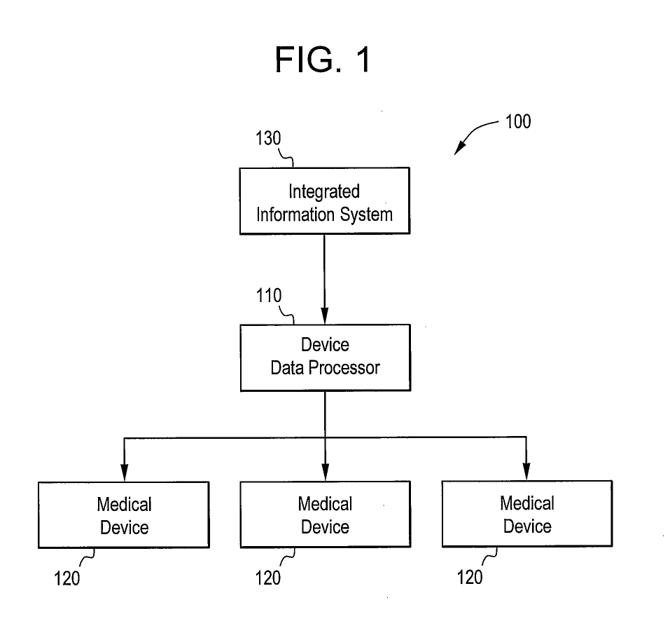

FIG. 1 illustrates a block diagram of a data processing system 100 according to an embodiment of the present invention. The system 100 includes a device data processor 110, one or more medical devices 120, and an integrated information system 130.

The device data processor 110 is in communication with the medical devices 120, and the integrated information system 130.

In operation, the device data processor 110 is adapted to enable the medical devices 120 to be integrated with the integrated information system 130. That is, the device data processor 110 provides a level of indirection to the medical devices 120 for the integrated information system 130 allowing consistent and uniform communication with those devices. Thus, the integrated information system 130 is integrated with the device data processor 110 and is able to communicate with the medical devices 120 via the device data processor 110.

The medical devices 120 may include devices such as physiological monitors, infusion pumps, ventilators, oximeters, fetal monitors, lab instruments, anesthesia delivery units, respiratory care devices, electrocardiograms, portable vitals measuring equipment, warmers, dialysis machines, and/or patient at home monitoring devices.

The integrated information system 130 may include Clinical Information Systems (CIS), Electronic Medical Records (EMR), Hospital Information Systems (HIS), chronic care management systems, clinical decision support system, and/or alert engine, for example. In certain embodiments, more than one integrated information system 130 may be in communication with the device data processor 110.

The medical devices 120 may provide data in a wide range of formats and via a wide range of mechanisms. For example, an oximeter may provide data for blood oxygen saturation. As another example, a patient monitor may gather vital signs data, including blood pressure, heart rate, electrocardiogram (ECG), respiration rate, blood oxygen saturation, and temperature. The device data processor 110 is adapted to normalize, filter, enrich, and/or prioritize the data from the medical devices 120 to provide to the integrated information system 130. These capabilities are discussed in more detail below.

The data from the medical devices 120 may be provided as a stream of values for one or more parameters. For example, an electrocardiogram may provide a stream of values for the heart rate parameter, each value provided once per second or as a waveform. The data may be provided simply as a data value on a wire or communicated using a standard or proprietary protocol, for example. For example, the data may be communicated using a serial line protocol or a protocol such as HL7.

As an example, an embodiment of the present invention may be in communication with a ventilator in an ICU. The ventilator may include its own alarm system, should the ventilator fail or power be disconnected, for example. However, an ICU may be noisy or no one may be in attendance to hear the alarm. An embodiment of the present invention would receive the alarm signal from the ventilator and communicate the alarm to an integrated CIS and alert system to notify other healthcare providers outside of the immediate vicinity of the ventilator.

As another example, an embodiment of the present invention may be in communication with a monitor generating a waveform for a patient's heart rate, for example. Most of the waveform generated is “normal” and is not noteworthy. However, an embodiment of the present invention may monitor the waveform to detect anomalies and begin recording the data for reference by a physician.

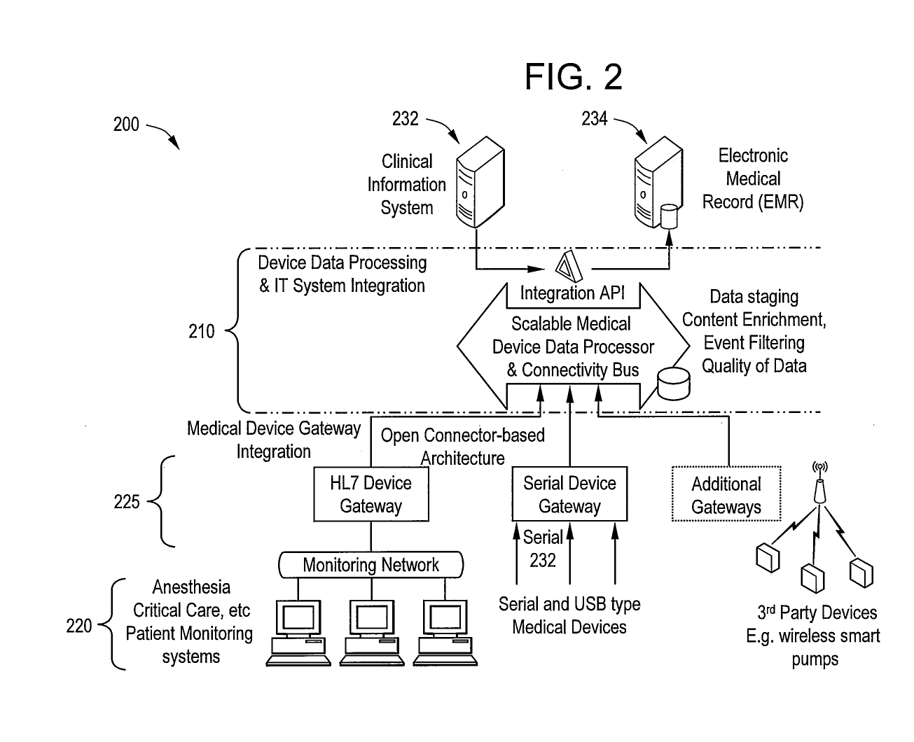

FIG. 2 illustrates a data processing system 200 according to an embodiment of the present invention. The system 200 includes a device data processor 210, one or more medical devices 220, one or more medical device gateways 225, a clinical information system 232, and an electronic medical record 234.

Each medical device 220 is in communication with a medical device gateway 225. Multiple medical devices 220 may be in communication with the same medical device gateway 225. The device data processor 210 is in communication with the medical device gateways 225 and the clinical information system 232 and the electronic medical record 234.

The device data processor 210 may be similar to the device data processor 110, discussed above, for example. A medical device 220 may be similar to a medical device 120, discussed above, for example. The clinical information system 232 may be similar to the integrated information system 130, discussed above, for example. The electronic medical record 234 may be similar to the integrated information system 130, discussed above, for example.

In operation, the medical devices 220 generate clinical data. The clinical data may be similar to the clinical data, discussed above, for example. The data is communicated to a medical device gateway 225. The medical device gateway 225 may perform protocol and/or format conversion on the data. The medical device gateway 225 then communicates the data to the device data processor 210. The device data processor 210 may then normalize, filter, enrich, and/or prioritize the data and provide it to an information system such as the clinical information system 232 and/or the electronic medical record 234.

The device data processor 210 is adapted to enable medical devices to be integrated with integrated information systems, such as the clinical information system 232 and/or the electronic medical record 234, in a consistent and uniform manner.

As mentioned above, one or more medical devices 220 may be in communication with a medical device gateway 225. The medical devices may be include, for example, anesthesia, critical care, and patient monitoring systems, for example.

A medical device gateway 225 may be provided by the manufacturer of a medical device 220 and/or the manufacturer of an information system such as clinical information system 232. The medical device gateways 225 are responsible for the low-level communication with the medical devices 220 using a variety of transport protocols such as RS323 serial communication, TCP/IP, HL7 MLLP, and XML/HTTP. One type of medical device gateway 225 is an HL7 device gateway, which allows medical devices 220 to communicate using the HL7 protocol. Another example of a medical device gateway 225 is a serial device gateway (or agent), which enables communication with serial and USB medical devices 220. As another example, a wireless medical device gateway 225 may allow communication with medical devices, such as smart pumps, wirelessly. In certain embodiments, a medical device gateway 225 may interface with a hospital's life-critical monitoring network which is able to communicate with patient monitors via their proprietary protocols, for example.

In current systems, the medical device gateway is directly integrated with an information system. Such integration leverages the proprietary interfacing mechanism provided by the vendor. Such solutions may be costly to integrate and do not easily scale.

The device data processor 210 is adapted to provide gateway connectors. In certain embodiments, the gateway connectors are part of a connectivity bus of the device data processor 210. The connectivity bus is adapted to decouple the medical device gateways 225 from the device data processor 220. Thus, gateway connectors (and corresponding medical device gateways 225) may be added or removed seamlessly without modification or affecting other components. The connectivity bus allows for scalability and extensibility in the data processing system 200. In certain embodiments, the connectivity bus may be implemented as a messaging bus. In certain embodiments, the connectivity bus may be implemented using the Message Bus pattern (see, e.g., http://www.enterpriseintegrationpatterns.com/MessageBus.html). In certain embodiments, scalability and extensibility are provided through late binding dependency injection. The late binding may allow processing pipelines and/or gateway connectors to be injected to extend the capabilities of the data processing system 200.

The gateway connectors allow the device data processor 210 to communicate with medical device gateways 225 from different vendors and/or communicating using different protocols. The gateway connectors of the device data processor 210 encapsulate the proprietary interfacing mechanism and protocols used by the medical device gateways 225. The gateway connectors are adapted to provide access to the data of the medical devices 220 from medical device gateways 225. In certain embodiments, the gateway connectors are adapted to normalize the data to a common format. For example, a blood pressure systolic measurement received from different vendors' devices may be normalized by a gateway connector with a common descriptor (e.g., “arterial blood_pressure_systolic”) and unit of measure (e.g., “mmHg”). Thus, the device data processor 210 may promote reusable connectors across consumer applications and access to a greater number of medical devices including support for third-party and legacy devices found at many hospitals today.

In certain embodiments, the gateway connectors are implemented based on Java Connector Architecture (JCA 1.5) standard (see, e.g., http://jcp.org/en/jsr/detail?id=112). In certain embodiments, the gateway connectors have an open architecture. The open architecture may provide a published interface to be implemented by gateway connector developers, for example.

In certain embodiments, the gateway connectors are adapted to connect to the device data processor 210 at start-up. In certain embodiments, the gateway connectors are adapted to connect to the device data processor 210 during run-time.

The device data processor 210 is adapted such that information systems, such as the clinical information systems 232 and/or the electronic medical record 234, may be integrated with the device data processor 210 one time. In certain embodiments, the device data processor 210 provides a rich Integration Application Programming Interface (API) to the information systems to be integrated. Thus, the device data processor 210 may provide a level of indirection to the medical devices 220.

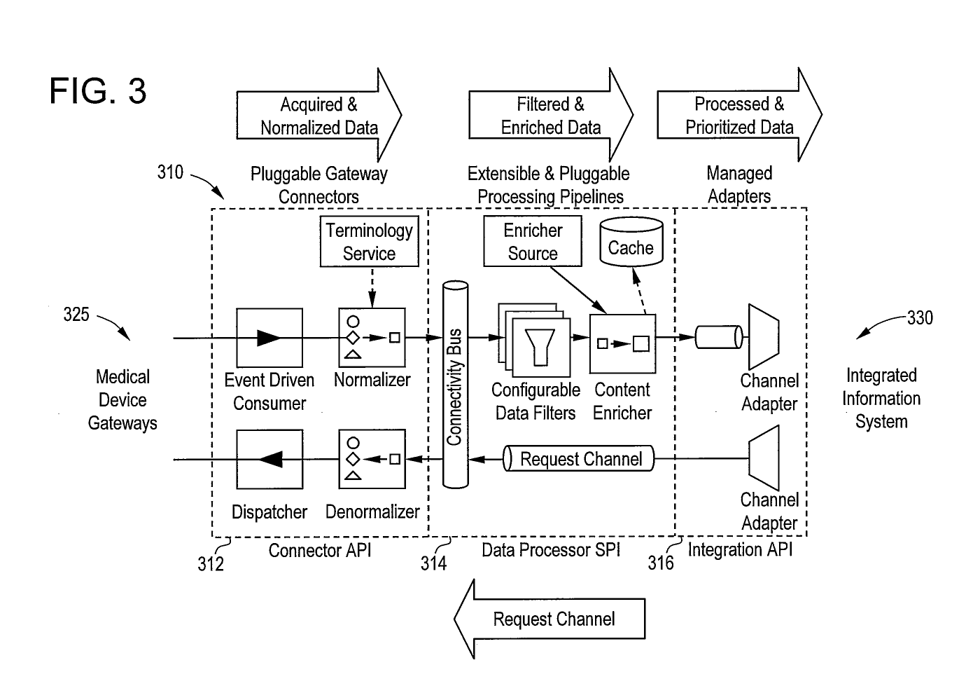

FIG. 3 illustrates a data flow diagram for a device data processor 310 according to an embodiment of the present invention. The device data processor 310 includes a connector component 312, a data processor component 314, and an integration component 316.

The data processor component 314 is in communication with the connector component 312 and the integration component 316. The device data processor 310 is in communication with one or more medical device gateways 325. The device data processor 310 is in communication with one or more integrated information systems 330.

The device data processor 310 may be similar to the device data processor 110 and/or the device data processor 210, discussed above, for example. The medical device gateway 325 may be similar to the medical device gateway 225, discussed above, for example. The integrated information system 330 may be similar to the integrated information system 130, discussed above, for example.

In operation, data is received from a medical device via the medical device gateway 325 at the connector component 312. The connector component 312 may then perform initial processing on the data and provides the data to the data processor component 314. The data processor component 314 then processes the data and communicates it to the one or more integrated information systems 330 via the integration component 316.

The connector component 312 is adapted to receive clinical data. The data is received from a medical device through the medical device gateway 325. In certain embodiments, the connector component 312 is a gateway connector and may be similar to the gateway connectors discussed above, for example. In certain embodiments, the connector component 312 is a pluggable connector which plugs into the connectivity bus allowing scalability. Pluggable connectors may be added at any time to expand the capability of the system, for example.

In certain embodiments, the connector component 312 includes an event-driven consumer to trigger reception and processing of the data. The event-driven consumer may be associated with one or more medical device gateways 325. In certain embodiments, the event-driven consumer is triggered asynchronously, consuming data from the medical device gateway 325 when it is delivered.

In certain embodiments, the connector component 312 is adapted to normalize the data. The normalization may include converting the data to utilize a more common and/or standardized medical “vocabulary.” The connector component 312 may include a normalizer or parser to perform the normalization, for example. The normalizer may utilize a terminology service. The terminology service may provide a lookup capability to map the data to the common and/or standardized medical vocabulary. Similar device data from multiple vendors' devices may be labeled differently and have different units of measure making the data impractical for the clinical information system to use, for example. For example, heart rate from different devices may be labeled with a common descriptor and a common unit of measure.

The data is then passed from the connector component 312 to the data processor component 314. The data processor component 314 is adapted to route the data to one or more data processing pipelines. The data may be routed based on device type, for example. The data processing pipelines may be high-throughput, for example, to enable real-time processing of the data.

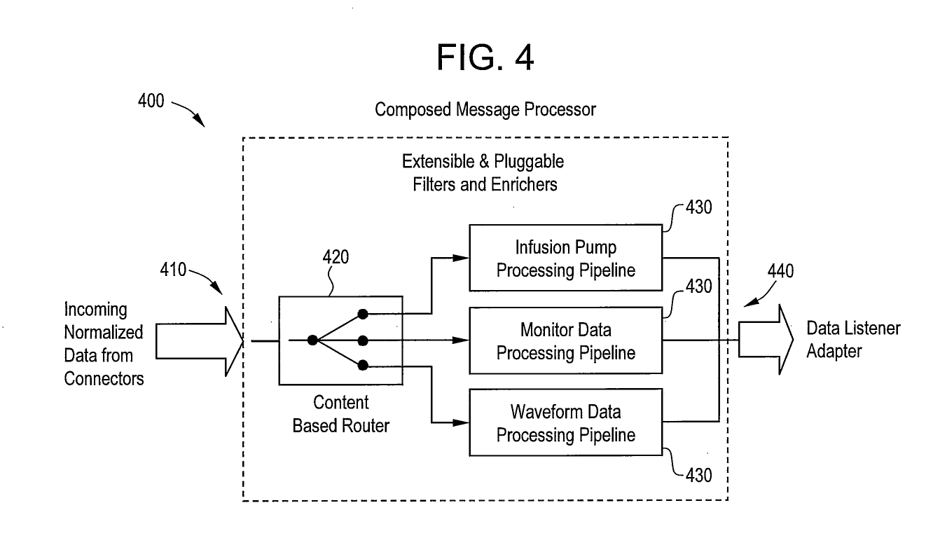

In certain embodiments, the data processor component 314 may be implemented as and/or include a composed message processor. FIG. 4 illustrates a composed message processor 400 of a device data processor according to an embodiment of the present invention. The composed message processor 400 includes a content-based router 420 in communication with one or more data processing pipelines 430.

In operation, the content-based router 420 receives data (possibly normalized) from a connector 410. The connector 410 may be part of and/or similar to the connector component 312, for example. The content-based router 420 then provides the data to one or more of the data processing pipelines 430 based on the nature of the data. The connector(s) 410 may label the data by type, such as wave-form data, monitor data, infusion pump data, and whether the data is measurements or alerts, for example. The routing determination by content-based router 420 may then be made based on the label given by the connector 410, for example.

The various data processing pipelines 430 then process the data to filter, enrich, and/or prioritize the data. Data may be stored (persisted or cached) by the data processing pipelines 430 so that the previous value can be compared to the current value, for example. For example, the data may be sampled for a period of time and the median value calculated. The data processing pipelines 430 may include, for example, an infusion pump processing pipeline, a monitor data processing pipeline, and a waveform data processing pipeline. A data processing pipeline 430 may enrich the data by adding a patient identifier or other contextual information (meta-data) as required by downstream and consuming applications, for example. A data processing pipeline 430 may be composed of chained, event-driven stages, for example. Each stage may perform filtering and/or data enrichment functions. For example, the filters may include range filters (e.g., determines whether a data value is between allowed minimum and maximum values), temporal filters (e.g., determines if a rate has stabilized within a given time period), rule-based filters, and adaptive filters. Rule-based filters may be used to alter the data sampling intervals (e.g., for storage into the EMR), allowing the system to be adaptive to patient specific events. With respect to data enrichment, an example is the patient association function, which adds patient identifiers to the incoming medical device data. The filtering along with data enrichment may be used to improve data quality. In addition, the filtering and data enrichment may be used to prevent erroneous entry into the EMR of data that is inaccurate or unrepresentative, e.g. a heart rate that reads high due to interference from another electrical device or an inaccurate respiratory rate due to a patient's motion.

In certain embodiments, additional or customized data processing pipelines may be provide using a Service Provider Interface (SPI). An SPI is a software mechanism to support replaceable and extendable components. Developers implementing custom processing pipelines may use the SPI so that the data processor can be extended with additional functionality. Connectors and processing pipelines may be added to extend the capability of the system, for example.

In certain embodiments, JCA thread management is applied to SEDA to achieve synergistic effects such as self-tuning performance, protection against load spikes, and high-throughput message processing. For example, high-throughput data processing and massive scalability may be enabled by utilizing the Staged Event Driven Architecture (SEDA) model for the data processing pipelines. A stage may be composed of an event queue, event handlers, a JCA work manager (thread pool), and a stage controller. Events enter the stage via the event queue. The event queue introduces process and performance isolation per stage. The event queue also serves as the gatekeeper to a stage. If the stage is too busy processing, the queue may impose backpressure (per defined overload policy) for overload protection. The event handlers retrieve event data from the queue, perform some data processing and pass it onto the next stage. Each event handler may be run as a separate thread (worker). The stage controller may periodically monitors the queue's performance statistics and increase the number of threads in the thread pool depending upon the current load. This is referred to as adaptive resource scheduling (self-tuning performance). The stage controller may be implemented as a timer via the JCA Resource Adapter.

Once the data has been processed by a data processing pipeline 430, it is provided to a data listener 440. The data listener 440 may be part of an integration component similar to the integration component 316, discussed below, for example.

The integration component 316 includes a channel adapter. The channel adapter is adapted to receive the processed data from the data processor component 314. The channel adapter is further adapted to provide the processed data to one or more consuming applications. The consuming applications are the integration information systems 330.

In certain embodiments, the processed data may be stored in a staging database. The staging database may be utilized by the data processor component 314 to provide retrospective access to data, for example.

In certain embodiments, the device data processor 310 supports a request channel. The request channel allows an integrated information system 330 to communicate data to a medical device. For example, a clinical information system may initiate a connection and request data from devices when an urgent reading is desired. As another example, a clinical information system may send a dosage request to an infusion pump and the pump could automatically administer the dosage.

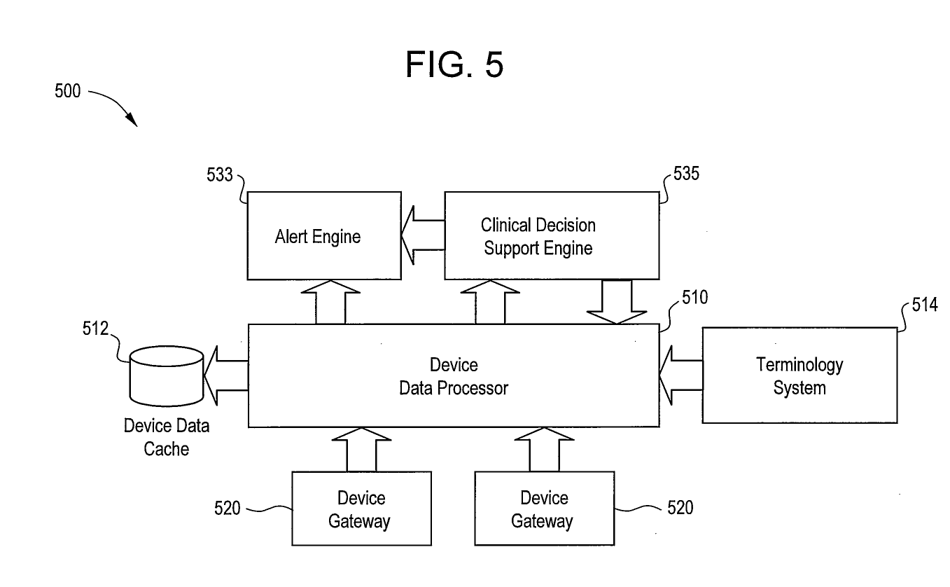

FIG. 5 illustrates an intelligent system 500 according to an embodiment of the present invention. The intelligent system 500 includes a device data processor 510, a device data cache 512, a terminology system 514, a plurality of medical device gateways 525, an alert engine 533, and a clinical decision support engine 535.

The device data processor 510 is in communication with the device data cache 512, the terminology system 514, the medical device gateways 525, the alert engine 533, and the clinical decision support engine 535. In certain embodiments, the clinical decision support engine 535 is in communication with the alert engine 533.

The device data processor 510 may be similar to the device data processor 110, the device data processor 210, and/or the device data processor 310, discussed above, for example. The medical device gateway 525 may be similar to the medical device gateway 225 and/or the medical device gateway 320, discussed above, for example. The device data cache 512 may be similar to the staging database, discussed above, for example. The terminology system 514 may be similar to the terminology service, discussed above, for example. The alert engine 533 may be similar to the integrated information system 130 and/or the integrated information system 330, discussed above, for example. The clinical decision support engine may be similar to the integrated information system 130 and/or the integrated information system 330, discussed above, for example.

In operation, similar to the data processing systems 100 and/or 200 discussed above, the intelligent system 500 receives data from medical devices through the medical device gateways 525. The data is processed by the device data processor 510 using the device data cache 514 and the terminology system 514. The processed data is then provided to the alert engine 533 and the clinical decision support engine 535.

The alert engine 533 may provide notifications and/or alerts to healthcare providers, for example. For example, the alert engine 533, based on data received from the device data processor 510 and/or data from the clinical decision support engine 535, may provide a notification if the data falls outside the normal range for the particular device. The alert engine 533 may also send out alerts in the case of a device malfunction, for example. As another example, an alert may be sent out in the case of changes in the health conditions of chronically ill patients being monitored at home, such as diabetics or high blood pressure patients, who may need a change in treatment. The alert may be in various forms, including but not limited to e-mail, pager alerts, and/or instant messages, for example.

The clinical decision support engine 535 may examine the data to detect potential problems, make recommendations, and verify correctness, for example. For example, the clinical decision support engine 535, based on the data received from the device data processor 510, may warn of changes in a patient's condition in real-time when attached to a patient-monitoring device like an ECG or a pulse oximeter. As another example, the clinical decision support engine 535 may check the dosage prescribed to a patient when connected to an IV infusion pump, warn of potential dosage errors, drug-to-drug interactions, and medication allergies. As another example, the clinical decision support engine 535 may scan laboratory test results, drug or test orders, or the EMR, and then send reminders or warnings when connected to laboratory devices. As another example, the clinical decision support engine 535 may alert a clinician when detecting patterns in the clinical data that suggests changes in the patient's condition. As another example, the clinical decision support engine 535 may broadcast alerts to nurses and clinician in case of an accidental ventilator disconnect in the ICU. As another example, the clinical decision support engine 535 may generate alerts if a patient receives 100% oxygen for more than 1 hour. The warnings and alerts may be provided using the alert engine 53, for example.

In certain embodiments, the intelligent system 500 may create new clinical knowledge when used in research settings. For example, Hau and Coiera (1997) (FN: http://www.coiera.com/aimd.htm) describe a learning system that takes real-time patient data obtained during cardiac bypass surgery, and then creates models of normal and abnormal cardiac physiology. These models might be used to look for changes in a patient's condition if used at the time they are created. The intelligent system 500 may create a baseline from which it is possible to detect changes in a patients' condition and need for care, for example. As another example, the processing pipelines may be controlled by the intelligent system 500 to adjust device parameters to determine the patient's response. As another example, the intelligent system 500 may request changes in patient care and constant monitoring during the changes to determine the effectiveness of such changes.

The components, elements, and/or functionality of the interface(s) and system(s) discussed above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device, such as, for example, a PACS workstation or one or more dedicated processors.

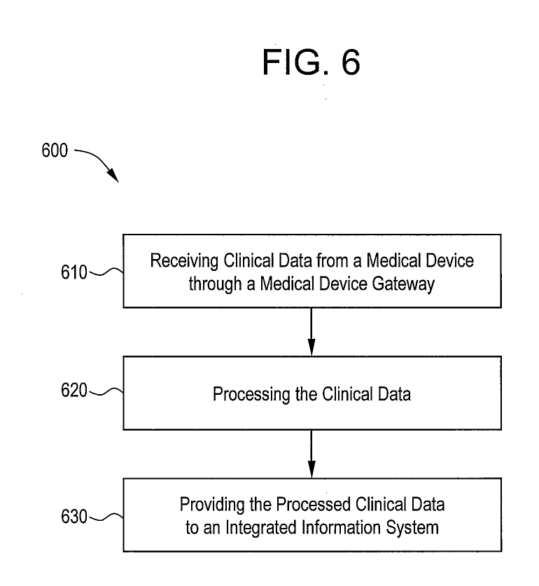

FIG. 6 illustrates a flow diagram 600 for a method for processing medical device data according to an embodiment of the present invention. The method includes the following steps, which will be described below in more detail. At step 610, clinical data is received from a medical device through a medical device gateway. At step 620, the clinical data is processed. At step 630, the processed clinical data is provided to an integrated information system. The method is described with reference to elements of systems discussed above, but it should be understood that other implementations are possible.

At step 610, clinical data is received from a medical device through a medical device gateway. The medical device may be similar to the medical devices 120 and/or 220, discussed above, for example. The medical device gateway may be similar to the medical device gateways 225 and/or 325, discussed above, for example.

The clinical data may be received at a device data processor. The device data processor may be similar to the device data processors 110, 210, and/or 310, discussed above, for example. The clinical data may be received by a connector component similar to the connector component 312, discussed above, for example. In certain embodiments, the data is received by a gateway connector. The gateway connector may be similar to the gateway connector, discussed above, for example.

In certain embodiments, the reception of the clinical data is performed using an event-driven consumer to trigger reception and processing of the data. The event-driven consumer may be associated with one or more medical device gateways. In certain embodiments, the event-driven consumer is triggered asynchronously, consuming data from the medical device gateway when it is delivered.

At step 620, the clinical data is processed. The clinical data may be processed by a device data processor. The device data processor may be similar to the device data processors 110, 210, and/or 310, discussed above, for example. In certain embodiments, the device data processor may be implemented as and/or include a composed message processor similar to the composed message processor, discussed above, for example.

In certain embodiments, the received clinical data is normalized a common format. The normalization may include converting the data to utilize a more common and/or standardized medical “vocabulary.” The normalization may be performed by a normalizer or parser, for example. The normalizer may utilize a terminology service. The terminology service may provide a lookup capability to map the data to the common and/or standardized medical vocabulary.

The data is then routed to one or more data processing pipelines. The data may be routed by a content-based router similar to the content-based router 420, discussed above, for example. The data processing pipelines may be similar to the data processing pipelines 430, discussed above, for example. The data may be routed based on device type, for example. The data processing pipelines may be high-throughput, for example, to enable real-time processing of the data.

The various data processing pipelines may then process the data to filter, enrich, and/or prioritize the data. In certain embodiments, a data processing pipeline may be composed of chained, event-driven stages, for example. Each stage may perform filtering and/or data enrichment functions. For example, the filters may include range filters (e.g., determines whether a data value is between allowed minimum and maximum values), temporal filters (e.g., determines if a rate has stabilized within a given time period), rule-based filters, and adaptive filters. Rule-based filters may be used to alter the data sampling intervals (e.g., for storage into the EMR), allowing the system to be adaptive to patient specific events. With respect to data enrichment, an example is the patient association function, which adds patient identifiers to the incoming medical device data. The filtering along with data enrichment may be used to improve data quality. In addition, the filtering and data enrichment may be used to prevent erroneous entry into the EMR of data that is inaccurate or unrepresentative, e.g. a heart rate that reads high due to interference from another electrical device or an inaccurate respiratory rate due to a patient's motion.

In certain embodiments, JCA thread management is applied to SEDA to achieve synergistic effects such as self-tuning performance, protection against load spikes, and high-throughput message processing. For example, high-throughput data processing and massive scalability may be enabled by utilizing the Staged Event Driven Architecture (SEDA) model for the data processing pipelines. A stage may be composed of an event queue, event handlers, a JCA work manager (thread pool), and a stage controller. Events enter the stage via the event queue. The event queue introduces process and performance isolation per stage. The event queue also serves as the gatekeeper to a stage. If the stage is too busy processing, the queue may impose backpressure (per defined overload policy) for overload protection. The event handlers retrieve event data from the queue, perform some data processing and pass it onto the next stage. Each event handler may be run as a separate thread (worker). The stage controller may periodically monitors the queue's performance statistics and increase the number of threads in the thread pool depending upon the current load. This is referred to as adaptive resource scheduling (self-tuning performance). The stage controller may be implemented as a timer via the JCA Resource Adapter.

At step 630, the processed clinical data is provided to an integrated information system. The integrated information system may be similar to the integrated information systems 130 and/or 330, discussed above, for example.

In certain embodiments, the processed clinical data is provided to a data listener. The data listener may be similar to the data listener 440, discussed above, for example. The data listener may be part of an integration component similar to the integration component 316, discussed above, for example.

In certain embodiments, the processed clinical data is provided using a channel adapter. The channel adapter is adapted to receive the processed clinical data and to provide the processed data to one or more consuming applications. The consuming applications are the integration information systems.

In certain embodiments, the processed data may be stored in a staging database. The staging database may be utilized to provide retrospective access to data, for example.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

One or more of the steps of the method may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Thus, certain embodiments of the present invention provide a high-throughput and scalable medical device data processing engine and connectivity bus leveraging an open connector-based architecture for easy and consistent integration of medical devices with information systems such as CIS. Certain embodiments enable enhanced computerized decision support, access to a broader range of devices, and tighter device-EMR integration. Certain embodiments provide data analysis, mining, and quality improvement of medical device data, allowing more effective computerized decision support. Certain embodiments allow for highly effective intelligent systems can be created when combined with clinical decision support engines. Certain embodiments provide uniform access to medical device data. Certain embodiments provide simplified and uniform integration of diverse sets of medical devices. Certain embodiments of the present invention provide a technical effect of a high-throughput and scalable medical device data processing engine and connectivity bus leveraging an open connector-based architecture for easy and consistent integration of medical devices with information systems such as CIS. Certain embodiments a technical effect of enabling enhanced computerized decision support, access to a broader range of devices, and tighter device-EMR integration. Certain embodiments provide a technical effect of data analysis, mining, and quality improvement of medical device data, allowing more effective computerized decision support. Certain embodiments provide a technical effect of allowing for highly effective intelligent systems can be created when combined with clinical decision support engines. Certain embodiments provide a technical effect of uniform access to medical device data. Certain embodiments provide a technical effect of simplified and uniform integration of diverse sets of medical devices.

Several embodiments are discussed above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems, and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any healthcare information processing system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A medical device data processor comprising:
a connector component adapted to receive clinical data from a plurality of medical devices;
a data processor component adapted to receive the clinical data from the connector component, wherein the data processor component comprises a content-based router and a plurality of data processing pipelines, wherein the content-based router is adapted to provide the clinical data to one or more of the plurality of data processing pipelines, and wherein the data processing pipelines are adapted to process the clinical data; and
an integration component adapted to receive the processed clinical data from the data processor component and provide the processed clinical data to an integrated information system.

2. The medical device data processor of claim 1, wherein the connector component is adapted to receive the clinical data from the plurality of medical devices through at least one medical device gateway.

3. The medical device data processor of claim 1, wherein the connector component includes an event-driven consumer adapted to asynchronously trigger reception of the clinical data.

4. The medical device data processor of claim 1, wherein the connector component includes a normalizer adapted to normalize the clinical data to a standard medical vocabulary.

5. The medical device data processor of claim 4, wherein the normalizer utilizes a terminology service.

6. The medical device data processor of claim 1, wherein the data processor component is further adapted to receive the clinical data from the connector component through a connectivity bus, wherein the connectivity bus is adapted to provide seamless scalability by allowing one or more medical device gateways to be at least one of added and removed from communication with the medical device data processor.

7. The medical device data processor of claim 6, wherein the connectivity bus is implemented using one of a messaging bus and late binding dependency injection.

8. The medical device data processor of claim 1, wherein at least one of the plurality of data processing pipelines comprises a plurality of chained, event-driven stages.

9. The medical device data processor of claim 8, wherein each stage comprises an event queue, an event handler, a thread pool, and a stage controller, wherein the queue is adapted to impose backpressure, wherein the event handler is adapted to retrieve data from the event queue and process the data using the thread pool, and wherein the stage controller is adapted to alter the number of threads in the thread pool based on load.

10. The medical device data processor of claim 1, wherein at least one of the plurality of data processing pipelines is user customizable through a service provider interface.

11. The medical device data processor of claim 1, wherein the data processor component further comprises a staging database adapted to provide previously processed data to a data processing pipeline for retrospective analysis.

12. The medical device data processor of claim 1, wherein the integration component is adapted to provide the processed clinical data to a plurality of integrated information systems.

13. The medical device data processor of claim 1, wherein the integrated information system comprises at least one of a clinical information system, a clinical decision support system, and an electronic medical record.

14. A method for processing medical device data, the method comprising:
receiving clinical data from a plurality of medical devices at a device data processor through a plurality of medical device gateways;
processing the clinical data at the device data processor using a content-based router and a plurality of data processing pipelines, wherein the content-based router is adapted to provide the clinical data to one or more of the plurality of data processing pipelines, and wherein the data processing pipelines are adapted to process the clinical data; and
providing the processed clinical data to an integrated information system.

15. The method of claim 14, further including normalizing the clinical data to a standard medical vocabulary.

16. The method of claim 14, wherein the processing step utilizes at least one data processing pipeline comprises a plurality of chained, event-driven stages.

17. The method of claim 16, wherein each stage comprises an event queue, an event handler, a thread pool, and a stage controller, wherein the queue is adapted to impose backpressure, wherein the event handler is adapted to retrieve data from the event queue and process the data using the thread pool, and wherein the stage controller is adapted to alter the number of threads in the thread pool based on load.

18. The method of claim 14, wherein the processing step utilizes a staging database adapted to provide previously processed data to a data processing pipeline for retrospective analysis.

19. The method of claim 14, further comprising providing the processed clinical data to a second integrated information system.

20. A computer-readable medium including a set of instructions for execution on a computer, the set of instructions comprising:
a connector component routine configured to receive clinical data from a plurality of medical devices;
a data processor component routine configured to receive the clinical data from the connector component routine, wherein the data processor component routine comprises a content-based router routine and a plurality of data processing pipeline routines, wherein the content-based router routine is configured to provide the clinical data to one or more of the plurality of data processing pipeline routines, and wherein the data processing pipeline routines are configured to process the clinical data; and
an integration component routine configured adapted to receive the processed clinical data from the data processor component and provide the processed clinical data to an integrated information system.
